(19) United States
(12) Patent Application Publication
(10) Pub. No.: US 2011/0114555 A1
(43) Pub. Date: May 19, 2011

(54) FILTRATION MEDIA

(75) Inventors: Stephen Coulson, Abingdon (GB); Stephen Russell, Harrogate (GB); Matthew Tipper, York (GB)

(73) Assignee: P2i Ltd.

(21) Appl. No.: 12/995,704

(22) PCT Filed: Jun. 1, 2009
(86) PCT No.: PCT/GB09/50596

§ 371 Date: Feb. 2, 2011

(30) Foreign Application Priority Data
Jun. 6, 2008 (GB) 0810326.9

(51) Int. Cl. B01D 39/16; C08J 7/18

(52) U.S. Cl. 210/508; 427/488; 427/490

(57) ABSTRACT

A fibrous filtration media such as an electrostatic filtration media, whose fibre surfaces have been modified by exposure to a plasma deposition process so as to deposit a polymeric coating thereon.

The present invention relates to fibrous filtration media, in particular nonwoven or woven filtration media which are in particular reusable or intended for prolonged use or use in particular circumstances such as in electrostatic filtration, as well as methods for treating these so as to enhance their properties in particular in terms of their filtration efficiency and anti-caking properties.

Filtration of solids from liquids or gases is widely used in many fields including the biosciences, industrial processing, laboratory testing, food & beverage, electronics and water treatment. A wide variety of materials may be used to carry out such processes including porous membranes or other types of media.

Membrane filters are porous or microporous films used to carry out these types of operation. Membrane filters are produced by various methods, including casting methods such as spin casting, dip casting and doctor blade casting.

However, other types of material and in particular fibrous materials are used in some situations, in particular, for the removal of for example dust particles from air. Airborne dust particles, in particular those that are insoluble in body fluids present a major health hazard and can give rise to or exacerbate respiratory disease. They are therefore frequently removed in for example, air conditioning systems and in particular in respirators used for treating patients with respiratory disease.

Fibrous filtration media may be of a conventional woven material, where the pore size depends upon the relative arrangement of the warp and weft of the material. However, in many cases nonwoven materials are used. These may be constructed by providing layers or sheets of relatively randomly arranged fibres, for example using a conventional carding procedure, followed by lapping and mechanical bonding using barbed needles or points of a desired size. The action of the needles passing through the massed fibres has the effect of binding them together and, at the same time, creating a pore structure of a predetermined size distribution in the fabric.

These media are generally of a polymeric material and in particular a robust polymeric material such as polytetrafluoroethylene (PTFE), polyethylene terephthalate, polypropylene, cellulose diacetate, modacrylic and acrylic but they may also comprise natural fibres such as wool, cotton or silk, or resins. They are robust and reliable filtration media with a wide variety of applications.

However, they require cleaning at regular intervals to ensure that they do not become clogged with dust. Cleaning may be carried out using techniques such as air blasting and the like. However, a problem may arise if solid masses or cakes of particles are formed on the media. These cakes may adhere to an extent that they are not fully or easily removed during a conventional air blasting process.

Hitherto, the problem has been addressed by applying liquid chemical treatments and in particular fluorocarbon chemical treatments have been applied. However, the results achievable are limited.

In addition, some of these fibrous media have particular application in the field of electrostatic filtration. The use of electrostatic filtration media is commonplace in particulate respirators. Electrets have a semi-permanent electric field (just as magnets have a permanent magnetic field) and the electrostatic charge on the electret fibre improves the filtration efficiency over that of purely mechanical filters.

An additional advantage is the electrostatic media's large pore size compared to mechanical filter media of similar performance. Filtration devices that employ electrostatic filter media can therefore be made lighter in weight and more compact than equivalents from mechanical filter media.

The fibres used in the construction of these filters must be able to hold a charge (become tribocharged), and certain polymers such as polypropylene, cellulose diacetate, poly(ethylene terephthalate), nylon, polyvinyl chloride, modacrylic and acrylic as well as cotton, silk or wool (which may be chlorinated or otherwise treated for example by coating with nylon, may be suitable).

In particular, mixtures of both positively charged and negatively charged fibres form a good basis for an electrostatic filter. Examples of suitable mixtures are described by Smith et al., Journal of Electrostatics, 21, (1988) 81-98, the content of which is incorporated herein by reference.

However, the efficiency of electrostatic filter media can be reduced by exposure to certain aerosols to a far greater extent than mechanical filters. This potential reduction in filter efficiency is a problem, in particular in cases where maintenance of performance is critical, such as in respirators and the like.

A number of mechanisms have been proposed to explain this phenomenon. For instance, it is thought that neutralisation of the charge on the fibre by opposite charges of the captured aerosol particles may be a factor. Alternatively, a layer of captured particles may be shielding the charged fibres. In the case of liquid aerosols, there is a possibility that ionic conduction occurs through the liquid film on the fibre, resulting in discharge of the electret. Finally, there is also a possibility that, depending upon the nature of the fibre and the aerosol, the aerosol modifies the electret fibre itself due to chemical reaction or dissolution.

Plasma deposition techniques have been quite widely used for the deposition of polymeric coatings onto a range of surfaces, and in particular onto fabric surfaces. This technique is recognised as being a clean, dry technique that generates little waste compared to conventional wet chemical methods. Using this method, plasmas are generated from organic molecules, which are subjected to an electrical field. When this is done in the presence of a substrate, the radicals of the compound in the plasma polymerise on the substrate. Conventional polymer synthesis tends to produce structures containing repeat units that bear a strong resemblance to the monomer species, whereas a polymer network generated using a plasma can be extremely complex. The properties of the resultant coating can depend upon the nature of the substrate as well as the nature of the monomer used and conditions under which it is deposited.

Treatment of filtration membranes using a plasma polymerisation process to prevent the retention of reagents on the surface is described in WO2007/0813121. The membranes in that case however are generally of cheap materials such as cellulose or nitrocellulose and these are for single use and therefore considered to be ‘laboratory consumables’.

However, the effects of such treatment on fibrous filtration media, and in particular the types of fibrous media used in electrostatic filtration has not been reported previously. Therefore the effect of such treatment on the performance and reliability of such media is not understood.

The applicants have found that by treating fibrous filtration media using such a process the performance of the media may be enhanced significantly.

According to the present invention there is provided a fibrous filtration media whose surface has been modified by exposure to a plasma deposition process so as to deposit a polymeric coating thereon.

Treatment in this way has been found to have no significant effect on the air permeability of the media. This may be due to the fact that the polymeric coating layer deposited thereon is only molecules thick. However, depending upon the nature of the material deposited, the properties of fibrous filtration media, for example in terms of the anti-caking properties of the media. In the case of electrostatic filtration media, the performance as demonstrated by the aerosol test, may be enhanced significantly.

Furthermore, the polymeric coating material becomes molecularly bound to the surface and so there are no leachables; the modification becomes part of the media.

The media may be preformed and then subject to an appropriate plasma deposition process, or the fibres used to form the media may be treated before they are formed into a media using conventional methods. The highly penetrating nature of the plasma treatment means that the form of the material treated is not critical, as it will penetrate deep into pores or into massed fibres. Where the fibres are plasma treated prior to the assembly of the fabric, they may be blended with untreated fibres in various proportions to control the level of electrostatic charging that is achieved in the resultant fabric.

The polymeric coating may comprise a hydrophobic coating. A hydrophobic coating prevents liquid ingress whilst allowing gas or air to pass through the media. This is particularly useful for venting applications, for example as used in medical, electronic and automotive applications, for example for sensors, headlamps, hearing aids, mobile phones, transducers, laboratory equipment etc.

Media treated in accordance with the invention may be used in liquid and gas filters, in glass fibre filtration media and also in medical and healthcare applications, such as in filters used in haemodialysis, wound dressings and surgical smoke filters. It is particularly suitable for electrostatic filter media, used for example for the removal of airborne dust particles. Therefore, whilst air can continue to pass through them, particles and in particular dust particles will become trapped in the media.

The selection of the monomer and conditions of the process (for example pulse cycle, pressure and power) are selected so that the presence of a free radical initiator is not required to initiate polymerisation. The conditions used lead to ‘hard ionisation’ in which there is at least some fragmentation of the monomer in the plasma process. This fragmentation creates the active species for polymerisation.

Furthermore, the monomer and process conditions are selected so that the fibrous filtration media or fibres do not experience any change to their surface hardness following the plasma deposition process. Additionaly, the monomer and process conditions are such that the pore sizes of the fibrous filtration media remain the unchanged following the plasma deposition process.

Any monomer that undergoes plasma polymerisation or modification of the surface to form a suitable polymeric coating layer or surface modification on the surface of the filtration media may suitably be used. Examples of such monomers include those known in the art to be capable of producing hydrophobic polymeric coatings on substrates by plasma polymerisation including, for example, carbonaceous compounds having reactive functional groups, particularly substantially —CF₃ dominated perfluoro compounds (see WO 97/38801), perfluorinated alkenes (Wang et al., Chem Mater 1996, 2212-2214), hydrogen containing unsaturated compounds optionally containing halogen atoms or perhalogenated organic compounds of at least 10 carbon atoms (see WO 98/58117), organic compounds comprising two double bonds (WO 99/64662), saturated organic compounds having an optionally substituted alky chain of at least 5 carbon atoms optionally interposed with a heteroatom (WO 00/05000), optionally substituted alkynes (WO 00/20130), polyether substituted alkenes (U.S. Pat. No. 6,482,531B) and macrocycles containing at least one heteroatom (U.S. Pat. No. 6,329,024B), the contents of all of which are herein incorporated by reference.

A particular group of monomers which may be used to produce the media of the present invention include compounds of formula (I)

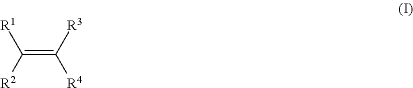

where R¹, R² and R³ are independently selected from hydrogen, halo, alkyl, haloalkyl or aryl optionally substituted by halo; and R⁴ is a group —X—R⁵ where R⁵ is an alkyl or haloalkyl group and X is a bond; a group of formula —C(O)O—, a group of formula —C(O)O(CH₂)ₙY— where n is an integer of from 1 to 10 and Y is a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0; for a sufficient period of time to allow a polymeric layer to form on the surface.

As used therein the term “halo” or “halogen” refers to fluorine, chlorine, bromine and iodine. Particularly preferred halo groups are fluoro. The term “aryl” refers to aromatic cyclic groups such as phenyl or naphthyl, in particular phenyl. The term “alkyl” refers to straight or branched chains of carbon atoms, suitably of up to 20 carbon atoms in length. The term “alkenyl” refers to straight or branched unsaturated chains suitably having from 2 to 20 carbon atoms. “Haloalkyl” refers to alkyl chains as defined above which include at least one halo substituent.

Suitable haloalkyl groups for R¹, R², R³ and R⁵ are fluoroalkyl groups. The alkyl chains may be straight or branched and may include cyclic moieties.

For R⁵, the alkyl chains suitably comprise 2 or more carbon atoms, suitably from 2-20 carbon atoms and preferably from 4 to 12 carbon atoms.

For R¹, R² and R^{3,} alkyl chains are generally preferred to have from 1 to 6 carbon atoms.

Preferably R⁵ is a haloalkyl, and more preferably a perhaloalkyl group, particularly a perfluoroalkyl group of formula CₘF₂ₘ₊₁ where m is an integer of 1 or more, suitably from 1-20, and preferably from 4-12 such as 4, 6 or 8.

Suitable alkyl groups for R¹, R² and R³ have from 1 to 6 carbon atoms.

In one embodiment, at least one of R¹, R² and R³ is hydrogen. In a particular embodiment R¹, R², R³ are all hydrogen. In yet a further embodiment however R³ is an alkyl group such as methyl or propyl.

Where X is a group —C(O)O(CH₂)ₙY—, n is an integer which provides a suitable spacer group. In particular, n is from 1 to 5, preferably about 2.

Suitable sulphonamide groups for Y include those of formula —N(R⁷) SO₂⁻ where R⁷ is hydrogen or alkyl such as C₁₋₄alkyl, in particular methyl or ethyl.

In one embodiment, the compound of formula (I) is a compound of formula (II)

CH₂═CH—R⁵ (II)

where R⁵ is as defined above in relation to formula (I).

In compounds of formula (II), ‘X’ within the X—R⁵ group in formula (I) is a bond.

However in a preferred embodiment, the compound of formula (I) is an acrylate of formula (III)

CH₂═CR^{7a}C (O)O(CH₂)ₙR⁵ (III)

where n and R⁵ as defined above in relation to formula (I) and R^{7a} is hydrogen, C₁₋₁₀ alkyl, or C₁₋₁₀haloalkyl. In particular R^{7a} is hydrogen or C₁₋₆alkyl such as methyl. A particular example of a compound of formula (III) is a compound of formula (IV)

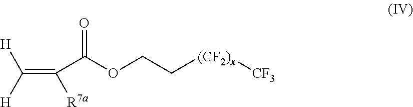

where R^{7a} is as defined above, and in particular is hydrogen and x is an integer of from 1 to 9, for instance from 4 to 9, and preferably 7. In that case, the compound of formula (IV) is 1H,1H,2H,2H-heptadecafluorodecylacylate.

According to a particular embodiment, the polymeric coating is formed by exposing the filtration media to plasma comprising one or more organic monomeric compounds, at least one of which comprises two carbon-carbon double bonds for a sufficient period of time to allow a polymeric layer to form on the surface.

Suitably the compound with more than one double bond comprises a compound of formula (V)

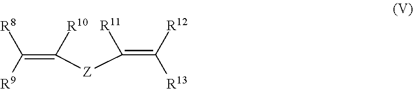

where R⁸, R⁹, R¹⁰, R¹¹, R¹², and R¹³ are all independently selected from hydrogen, halo, alkyl, haloalkyl or aryl optionally substituted by halo; and Z is a bridging group.

Examples of suitable bridging groups Z for use in the compound of formula (V) are those known in the polymer art. In particular they include optionally substituted alkyl groups which may be interposed with oxygen atoms. Suitable optional substituents for bridging groups Z include perhaloalkyl groups, in particular perfluoroalkyl groups.

In a particularly preferred embodiment, the bridging group Z includes one or more acyloxy or ester groups. In particular, the bridging group of formula Z is a group of sub-formula (VI)

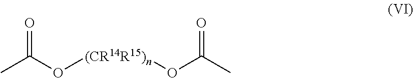

where n is an integer of from 1 to 10, suitably from 1 to 3, each R¹⁴ and R¹⁵ is independently selected from hydrogen, halo, alkyl or haloalkyl.

Suitably R⁸, R⁹, R¹⁰, R¹¹, R¹², and R¹³ are haloalkyl such as fluoroalkyl, or hydrogen. In particular they are all hydrogen.

Suitably the compound of formula (V) contains at least one haloalkyl group, preferably a perhaloalkyl group.

Particular examples of compounds of formula (V) include the following:

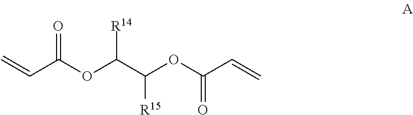

wherein R¹⁴ and R¹⁵ are as defined above and at least one of R¹⁴ or R¹⁵ is other than hydrogen. A particular example of such a compound is the compound of formula B.

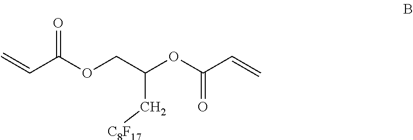

In a further embodiment, the polymeric coating is formed by exposing the filtration media to plasma comprising a monomeric saturated organic compound, said compound comprising an optionally substituted alkyl chain of at least 5 carbon atoms optionally interposed with a heteroatom for a sufficient period of time to allow a polymeric layer to form on the surface.

The term “saturated” as used herein means that the monomer does not contain multiple bonds (i.e. double or triple bonds) between two carbon atoms which are not part of an aromatic ring. The term “heteroatom” includes oxygen, sulphur, silicon or nitrogen atoms. Where the alkyl chain is interposed by a nitrogen atom, it will be substituted so as to form a secondary or tertiary amine. Similarly, silicons will be substituted appropriately, for example with two alkoxy groups.

Particularly suitable monomeric organic compounds are those of formula (VII)

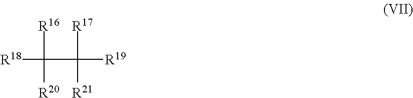

where R¹⁶, R¹⁷, R¹⁸, R¹⁹ and R²⁰ are independently selected from hydrogen, halogen, alkyl, haloalkyl or aryl optionally substituted by halo; and R²¹ is a group X—R²² where R²² is an alkyl or haloalkyl group and X is a bond or a group of formula —C(O)O(CH₂)ₓY— where x is an integer of from 1 to 10 and Y is a bond or a sulphonamide group; or a group —(O)ₚR²³(O)ₛ(CH₂)ₜ— where R²³ is aryl optionally substituted by halo, p is 0 or 1, s is 0 or 1 and t is 0 or an integer of from 1 to 10, provided that where s is 1, t is other than 0.

Suitable haloalkyl groups for R¹⁶, R¹⁷, R¹⁸, R¹⁹, and R²⁰ are fluoroalkyl groups. The alkyl chains may be straight or branched and may include cyclic moieties and have, for example from 1 to 6 carbon atoms.

For R²², the alkyl chains suitably comprise 1 or more carbon atoms, suitably from 1-20 carbon atoms and preferably from 6 to 12 carbon atoms.

Preferably R²² is a haloalkyl, and more preferably a perhaloalkyl group, particularly a perfluoroalkyl group of formula C_{z}F_{2z+1} where z is an integer of 1 or more, suitably from 1-20, and preferably from 6-12 such as 8 or 10.

Where X is a group —C(O)O(CH₂)_{y}Y—, y is an integer which provides a suitable spacer group. In particular, y is from 1 to 5, preferably about 2.

Suitable sulphonamide groups for Y include those of formula —N(R²³)SO₂⁻ where R²³ is hydrogen, alkyl or haloalkyl such as C₁₋₄alkyl, in particular methyl or ethyl.

The monomeric compounds used preferably comprises a C₆₋₂₅ alkane optionally substituted by halogen, in particular a perhaloalkane, and especially a perfluoroalkane.

According to another aspect, the polymeric coating is formed by exposing the constituent fibres or the filtration media itself to plasma comprising an optionally substituted alkyne for a sufficient period to allow a polymeric layer to form on the surface.

Suitably the alkyne compounds used comprise chains of carbon atoms, including one or more carbon-carbon triple bonds. The chains may be optionally interposed with a heteroatom and may carry substituents including rings and other functional groups. Suitable chains, which may be straight or branched, have from 2 to 50 carbon atoms, more suitably from 6 to 18 carbon atoms. They may be present either in the monomer used as a starting material, or may be created in the monomer on application of the plasma, for example by the ring opening

Particularly suitable monomeric organic compounds are those of formula (VIII)

R²⁴—C≡C—X¹—R²⁵ (VIII)

where R²⁴ is hydrogen, alkyl, cycloalkyl, haloalkyl or aryl optionally substituted by halo; X¹ is a bond or a bridging group; and R²⁵ is an alkyl, cycloalkyl or aryl group optionally substituted by halogen.

Suitable bridging groups X¹ include groups of formulae —(CH₂)ₛ—, —CO₂(CH₂)ₚ—, —(CH₂)ₚO(CH₂)_{q}—, —(CH₂)ₚN(R²⁶) CH₂)_{q}—, —(CH₂)ₚN(R²⁶)SO₂—, where s is 0 or an integer of from 1 to 20, p and q are independently selected from integers of from 1 to 20; and R²⁶ is hydrogen, alkyl, cycloalkyl or aryl. Particular alkyl groups for R²⁶ include C₁₋₆ alkyl, in particular, methyl or ethyl.

Where R²⁴ is alkyl or haloalkyl, it is generally preferred to have from 1 to 6 carbon atoms.

Suitable haloalkyl groups for R²⁴ include fluoroalkyl groups. The alkyl chains may be straight or branched and may include cyclic moieties. Preferably however R²⁴ is hydrogen.

Preferably R²⁵ is a haloalkyl, and more preferably a perhaloalkyl group, particularly a perfluoroalkyl group of formula CᵣF₂ᵣ₊₁ where r is an integer of 1 or more, suitably from 1-20, and preferably from 6-12 such as 8 or 10.

In a particular embodiment, the compound of formula (VIII) is a compound of formula (IX)

CH≡C(CH₂)ₛ—R²⁷ (IX)

where s is as defined above and R²⁷ is haloalkyl, in particular a perhaloalkyl such as a C₆₋₁₂ perfluoro group like C₆F₁₃.

In another embodiment, the compound of formula (VIII) is a compound of formula (X)

CH≡C(O)O(CH₂)ₚR²⁷ (X)

where p is an integer of from 1 to 20, and R²⁷ is as defined above in relation to formula (IX) above, in particular, a group C₈F₁₇. Preferably in this case, p is an integer of from 1 to 6, most preferably about 2.

Other examples of compounds of formula (I) are compounds of formula (XI)

CH≡C(CH₂)ₚO(CH₂)_{q}R²⁷, (XI)

where p is as defined above, but in particular is 1, q is as defined above but in particular is 1, and R²⁷ is as defined in relation to formula (IX), in particular a group C₆F₁₃;

or compounds of formula (XII)

CH≡C(CH₂)ₚN(R²⁶)(CH₂)_{q} R²⁷ (XII)

where p is as defined above, but in particular is 1, q is as defined above but in particular is 1, R²⁶ is as defined above an in particular is hydrogen, and R²⁷ is as defined in relation to formula (IX), in particular a group C₇F₁₅;

or compounds of formula (XIII)

CH≡C(CH₂)ₚN (R²⁶)SO₂R²⁷ (XIII)

where p is as defined above, but in particular is 1,R²⁶ is as defined above an in particular is ethyl, and R²⁷ is as defined in relation to formula (IX), in particular a group C₈F₁₇.

In an alternative embodiment, the alkyne monomer used in the process is a compound of formula (XIV)

R²⁸C≡C(CH₂)ₙSiR²⁹R³⁰R³¹ (XIV)

where R²⁸ is hydrogen, alkyl, cycloalkyl, haloalkyl or aryl optionally substituted by halo, R²⁹, R³⁰ and R³¹ are independently selected from alkyl or alkoxy, in particular C₁₋₆ alkyl or alkoxy.

Preferred groups R²⁸ are hydrogen or alkyl, in particular C₁₋₆ alkyl.

Preferred groups R²⁹, R³⁰ and R³¹ are C₁₋₆ alkoxy in particular ethoxy.

In general, the filtration media to be treated is placed within a plasma chamber together with the material to be deposited in a gaseous state, a glow discharge is ignited within the chamber and a suitable voltage is applied, which may be pulsed.

The polymeric coating may be produced under both pulsed and continuous-wave plasma deposition conditions but pulsed plasma may be preferred as this allows closer control of the coating, and so the formation of a more uniform polymeric structure.

As used herein, the expression “in a gaseous state” refers to gases or vapours, either alone or in mixture, as well as aerosols.

Precise conditions under which the plasma polymerization takes place in an effective manner will vary depending upon factors such as the nature of the polymer, the filtration media treated including both the material from which it is made and the pore size etc. and will be determined using routine methods and/or the techniques.

Suitable plasmas for use in the method of the invention include non-equilibrium plasmas such as those generated by radiofrequencies (RF), microwaves or direct current (DC). They may operate at atmospheric or sub-atmospheric pressures as are known in the art. In particular however, they are generated by radiofrequencies (RF).

Various forms of equipment may be used to generate gaseous plasmas. Generally these comprise containers or plasma chambers in which plasmas may be generated. Particular examples of such equipment are described for instance in WO2005/089961 and WO02/28548, but many other conventional plasma generating apparatus are available.

The gas present within the plasma chamber may comprise a vapour of the monomer alone, but it may be combined with a carrier gas, in particular, an inert gas such as helium or argon, if required. In particular helium is a preferred carrier gas as this can minimise fragmentation of the monomer.

When used as a mixture, the relative amounts of the monomer vapour to carrier gas is suitably determined in accordance with procedures which are conventional in the art. The amount of monomer added will depend to some extent on the nature of the particular monomer being used, the nature of the substrate being treated, the size of the plasma chamber etc. Generally, in the case of conventional chambers, monomer is delivered in an amount of from 50-250 mg/minute, for example at a rate of from 100-150 mg/minute. It will be appreciated however, that the rate will vary depending on the reactor size chosen and the number of substrates required to be processed at once; this in turn depends on considerations such as the annual through-put required and the capital outlay.

Carrier gas such as helium is suitably administered at a constant rate for example at a rate of from 5-90 standard cubic centimetres per minute (sccm), for example from 15-30 sccm. In some instances, the ratio of monomer to carrier gas will be in the range of from 100:0 to 1:100, for instance in the range of from 10:0 to 1:100, and in particular about 1:0 to 1:10. The precise ratio selected will be so as to ensure that the flow rate required by the process is achieved.

In some cases, a preliminary continuous power plasma may be struck for example for from 15 seconds to 10 minutes, for example from 2-10 minutes within the chamber. This may act as a surface pre-treatment step, ensuring that the monomer attaches itself readily to the surface, so that as polymerisation occurs, the coating “grows” on the surface. The pre-treatment step may be conducted before monomer is introduced into the chamber, in the presence of only an inert gas.

The plasma is then suitably switched to a pulsed plasma to allow polymerisation to proceed, at least when the monomer is present.

In all cases, a glow discharge is suitably ignited by applying a high frequency voltage, for example at 13.56 MHz. This is applied using electrodes, which may be internal or external to the chamber, but in the case of larger chambers are generally internal.

Suitably the gas, vapour or gas mixture is supplied at a rate of at least 1 standard cubic centimetre per minute (sccm) and preferably in the range of from 1 to 100 sccm.

In the case of the monomer vapour, this is suitably supplied at a rate of from 80-300 mg/minute, for example at about 120 mg/minute depending upon the nature of the monomer, the size of the chamber and the surface area of the product during a particular run whilst the pulsed voltage is applied. It may however, be more appropriate for industrial scale use to have a fixed total monomer delivery that will vary with respect to the defined process time and will also depend on the nature of the monomer and the technical effect required.

Gases or vapours may be delivered into the plasma chamber using any conventional method. For example, they may be drawn, injected or pumped into the plasma region. In particular, where a plasma chamber is used, gases or vapours may be drawn into the chamber as a result of a reduction in the pressure within the chamber, caused by use of an evacuating pump, or they may be pumped, sprayed, dripped, electrostatically ionised or injected into the chamber as is common in liquid handling.

Polymerisation is suitably effected using vapours of compounds for example of formula (I), which are maintained at pressures of from 0.1 to 400 mtorr, suitably at about 10-100 mtorr.

The applied fields are suitably of power of from 5 to 500 W for example from 20 to 500 W, suitably at about 100 W peak power, applied as a continuous or pulsed field. Where used, pulses are suitably applied in a sequence which yields very low average powers, for example in a sequence in which the ratio of the time on:time off is in the range of from 1:100 to 1:1500, for example at about 1:650. Particular examples of such sequence are sequences where power is on for 20-50 μs, for example about 30 μs, and off for from 1000 μs to 30000 μs, in particular about 20000 μs. Typical average powers obtained in this way are 0.1-0.2 W.

The fields are suitably applied from 30 seconds to 90 minutes, preferably from 5 to 60 minutes, depending upon the nature of the compound of formula (I) and the fibrous filtration media or the mass of fibres being treated.

Suitably a plasma chamber used is of sufficient volume to accommodate multiple media where these are preformed.

A particularly suitable apparatus and method for producing filtration media in accordance with the invention is described in WO2005/089961, the content of which is hereby incorporated by reference.

In particular, when using high volume chambers of this type, the plasma is created with a voltage as a pulsed field, at an average power of from 0.001 to 500 W/m³, for example at from 0.001 to 100 W/m³ and suitably at from 0.005 to 0.5 W/m³.

These conditions are particularly suitable for depositing good quality uniform coatings, in large chambers, for example in chambers where the plasma zone has a volume of greater than 500 cm³, for instance 0.1 m³ or more, such as from 0.5 m³-10 m³ and suitably at about 1 m³. The layers formed in this way have good mechanical strength.

The dimensions of the chamber will be selected so as to accommodate the particular filtration media sheets or batch of fibres being treated. For instance, generally cuboid chambers may be suitable for a wide range of applications, but if necessary, elongate or rectangular chambers may be constructed or indeed cylindrical, or of any other suitable shape.

The chamber may be a sealable container, to allow for batch processes, or it may comprise inlets and outlets for the filtration media, to allow it to be utilised in a continuous process as an in-line system. In particular in the latter case, the pressure conditions necessary for creating a plasma discharge within the chamber are maintained using high volume pumps, as is conventional for example in a device with a “whistling leak”. However it will also be possible to process sheets of filtration media or batches of fibres at atmospheric pressure, or close to, negating the need for “whistling leaks”.

A further aspect of the invention comprises a method of preparing a fibrous filtration media as described above, which method comprises exposing said media or fibres from which they may be constructed to a plasma polymerisation process as described above, so as to form a polymeric coating thereon, and if necessary thereafter, forming a fibrous filtration media from the fibres.

Another aspect of the invention comprises a method for preparing a fibrous filtration media according to any one of the preceding claims, said method comprising exposing either (i) a fibrous filtration media or (ii) fibres to a plasma comprising a hydrocarbon or fluorocarbon monomer in a plasma process without the presence of a free radical initiator so as to form a polymeric layer on the surface thereof, and in the case of (ii), forming a fibrous filtration media from said fibres, wherein the plasma is pulsed.

The polymeric layer formed on the surface may be hydrophobic.

In yet a further aspect, the invention provides a method of filtering fluids such as gases or liquids, said method comprising said method comprising passing fluid through a filtration media as described above. In particular the fluid is air and the media is an electrostatic media that removes solid particles such as dust particles from the air.

In yet a further aspect, the invention provides the use of a polymerised fluorocarbon or hydrocarbon coating, deposited by a plasma polymerisation process, for enhancing the anti-caking properties of a fibrous filtration media.

In addition, the invention provides the use of a polymerised fluorocarbon or hydrocarbon coating, deposited by a plasma polymerisation process, for enhancing the performance of a fibrous electrostatic filtration media.

Suitable fluorocarbon and hydrocarbon coatings are obtainable as described above.

The invention will now be particularly described by way of example, with reference to the accompanying diagrammatic drawings in which:

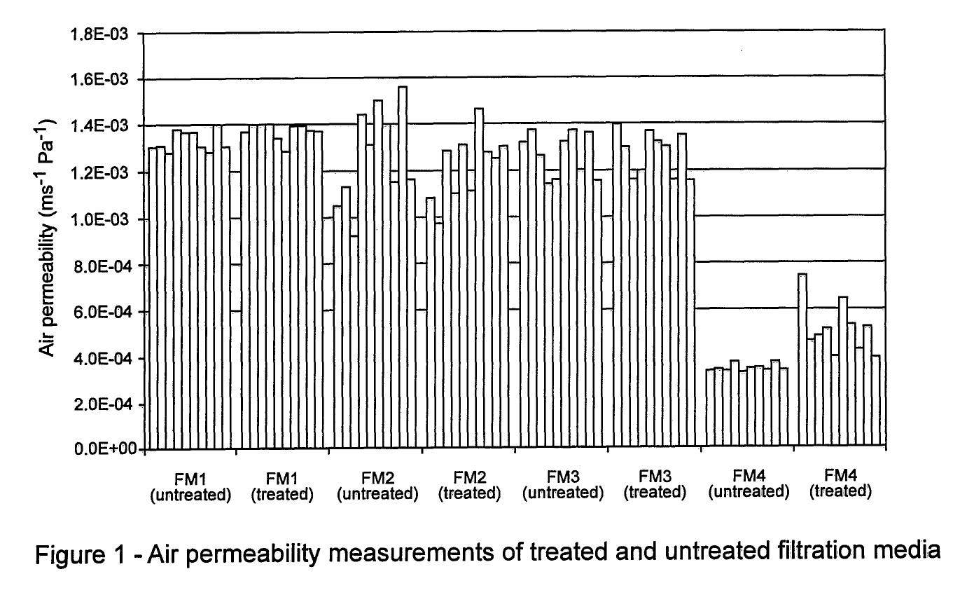

FIG. 1 is a graph showing the results of air permeability tests carried out on fibrous filtration media treated in accordance with the invention, and untreated;

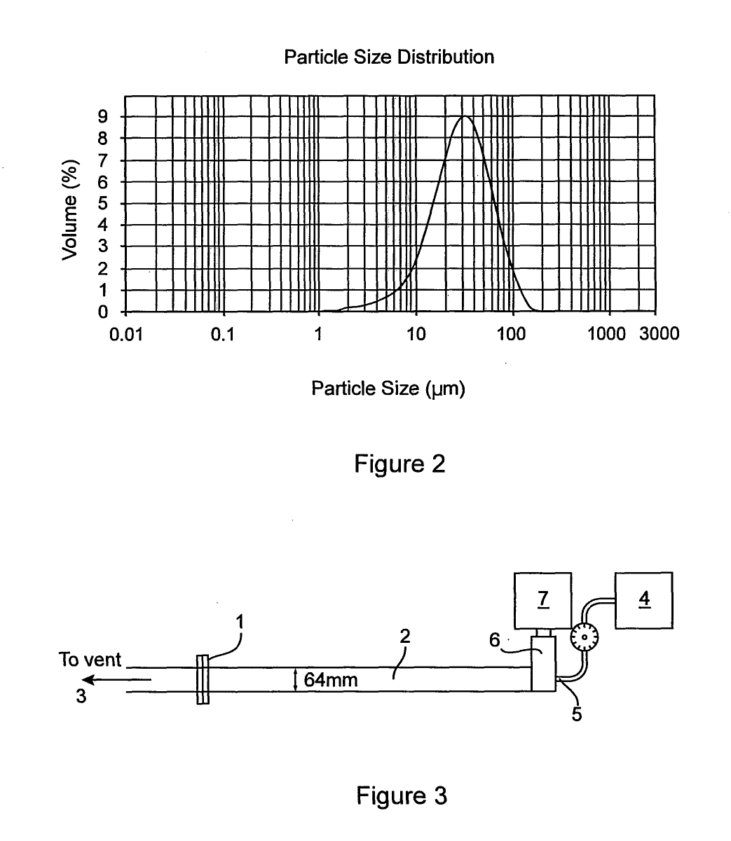

FIG. 2 shows the measured particle size distribution for dust used in filtration tests (see below);

FIG. 3 is a schematic diagram illustrating a test rig used for the determination of filtration cake release efficiency;

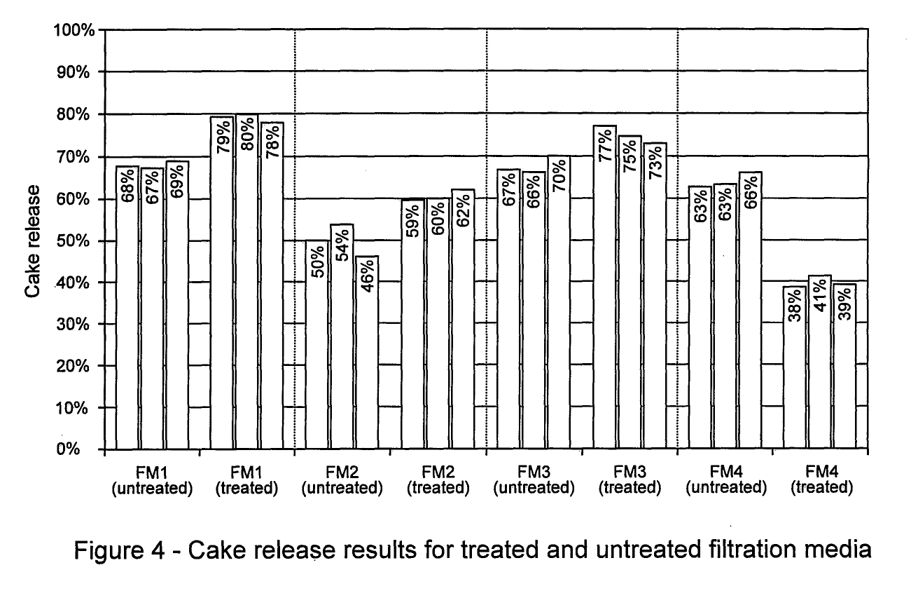

FIG. 4 is a graph showing the cake release result for treated and untreated filtration media; and

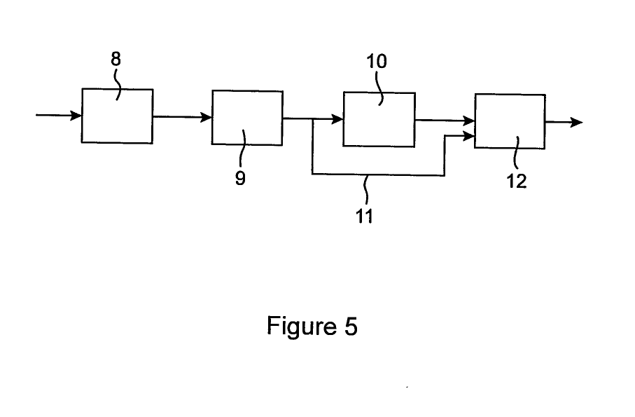

FIG. 5 is a schematic diagram of the apparatus used for a sodium chloride aerosol test.

### EXAMPLE 1

### Air Permeability Test

A series of tests were carried out on fibrous filtration media both with and without subjecting them to a plasma procedure. The media were characterised as follows:

| No. | Description |
|---|---|
| FM1 | Needlepunched poly(ethylene terephthalate) filtration |
| | media, mean area density of 550 gm⁻² |
| FM2 | Needlepunched filtration media with supporting scrim, |
| | consisting of hydrophobic (PTFE) fibre, mean area density |
| | of 750 gm⁻² |
| FM3 | Needlepunched poly(ethylene terephthalate) filtration |
| | media, with a fluorocarbon chemical treatment aimed at |
| | imparting water, oil and dust release characteristics and |
| | applied by the manufacturer, mean area density of 550 gm⁻² |
| FM4 | Needlepunched poly(ethylene terephthalate) filtration |
| | media with a PTFE membrane, mean area density of 500 gm⁻² |

Samples of each media were placed into a plasma chamber with a processing volume of ˜300 litres. The chamber was connected to supplies of the required gases and or vapours, via a mass flow controller and/or liquid mass flow meter and a mixing injector or monomer reservoir as appropriate.

The chamber was evacuated to between 3 and 10 mtorr base pressure before allowing helium into the chamber at 20 sccm until a pressure of 80 mtorr was reached. A continuous power plasma was then struck for 4 minutes using RF at 13.56 MHz at 300 W.

After this period, 1H,1H,2H,2H-heptadecafluorodecylacylate (CAS # 27905-45-9) of formula

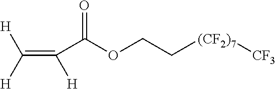

was brought into the chamber at a rate of 120 milligrams per minute and the plasma switched to a pulsed plasma at 30 microseconds on-time and 20 milliseconds off-time at a peak power of 100 W for 40 minutes. On completion of the 40 minutes the plasma power was turned off along with the processing gases and vapours and the chamber evacuated back down to base pressure. The chamber was then vented to atmospheric pressure and the media samples removed.

Fluid flow through homogenous, anisotropic, porous nonwoven structures can be described by Darcy's law:

$$q = \frac{k}{η} \times \frac{Δ p}{t}$$

Where q is the volumetric flow rate of the fluid flow, η is the viscosity of the fluid, Δp id the pressure drop along the conduit length of the fluid flow; k and t are the specific permeability and the thickness of the nonwoven filtration media respectively.

Values of specific permeability indicate the intrinsic permeability of a fabric exclusive of the influence of the fabric thickness and fluid type, meaning nonwoven structures of differing thickness can be compared.

The specific permeability of a nonwoven fabric can be calculated if the air permeability and the thickness of the material are measured.

The air permeability of each filtration media FM1-FM5 was measured in accordance with BS EN ISO 9237:1995 using a “Shirley” air permeability tester. Using this apparatus, the rate of flow of air passing perpendicularly through a given area of fabric is measured at a given pressure difference across the fabric test area.

Test conditions were as follows:

Test area: 5 cm²

Air pressure: 50 Pa/100 Pa

Each media, treated and untreated, was subjected to 10 tests. The test results are shown in FIG. 1 and Table 1 below.

TABLE 1

| | Media | | | | | | | |
|---|---|---|---|---|---|---|---|---|
| No | FM1 | | FM2 | | FM3 | | FM4 | |
| test | U | T | U | T | U | T | U | T |
| 1 | 65.2 | 68.4 | 52.4 | 54.0 | 66.0 | 69.6 | 16.5 | 37.0 |
| 2 | 65.4 | 70.2 | 56.4 | 48.0 | 68.6 | 64.8 | 16.8 | 23.0 |
| 3 | 64.0 | 70.2 | 46.0 | 64.0 | 63.0 | 58.0 | 16.5 | 24.0 |
| 4 | 69.0 | 70.2 | 72.0 | 55.0 | 57.0 | 50.0 | 18.5 | 25.6 |
| 5 | 68.4 | 67.0 | 65.4 | 65.2 | 58.0 | 68.2 | 16.0 | 19.5 |
| 6 | 68.4 | 64.2 | 75.0 | 55.5 | 66.2 | 66.0 | 17.0 | 32.0 |
| 7 | 65.2 | 69.6 | 70.0 | 73.0 | 68.4 | 65.0 | 17.2 | 26.4 |
| 8 | 64.0 | 69.6 | 57.5 | 63.8 | 60.0 | 57.8 | 16.7 | 21.0 |
| 9 | 70.0 | 68.6 | 77.8 | 62.5 | 68.0 | 67.4 | 18.3 | 25.8 |
| 10 | 65.2 | 68.4 | 58.0 | 65.0 | 57.6 | 57.6 | 16.6 | 19.3 |
| Mean | 66.5 | 68.6 | 63.0 | 60.6 | 63.3 | 63.4 | 17.0 | 25.4 |
| SD | 2.2 | 1.9 | 10.5 | 7.3 | 4.8 | 4.6 | 0.8 | 5.6 |
| CoV | 3.3% | 2.7% | 16.7% | 12.0% | 7.5% | 7.3% | 4.7% | 21.9% |

Where
U = untreated
T = treated
SD = Standard Deviation
CoV = Coefficient of variation

The mean thickness of the filtration media was measured from five individual readings on separate areas of the media using a Fast-1 (Fabric Assurance by Simple Testing) compression tester, which measures fabric thickness under a loading of 2.00 g cm⁻².

Using Darcy's law, specific permeability k can be calculated using the following equation.

$$k = \frac{q η t}{Δ p}$$

The calculated specific permeability values for the media are shown in Table 2.

TABLE 2
Measured thicknesses and calculated specific
permeability values for the media

| | Media | | | | | | | |
|---|---|---|---|---|---|---|---|---|
| | FM1 | | FM2 | | FM3 | | FM4 | |
| | U | T | U | T | U | T | U | T |
| Mean fabric | 2.23 | 2.23 | 1.59 | 1.59 | 2.15 | 2.12 | 1.96 | 2.1 [symbol] |
| thickness (mm) | | | | | | | | |
| Specific | 5.29 | 5.45 | 3.65 | 3.51 | 4.96 | 4.90 | 1.22 | 1.9 [symbol] |
| permeability | | | | | | | | |
| (10⁻¹¹ m²) | | | | | | | | |

[symbol]

indicates data missing or illegible when filed

The results show that the treatment does not have any significant effect on the air permeability of the filtration media tested with the exception of the PTFE membrane containing media (FM4). This media was supplied as two separate A4-sized sheets, one of which was treated and one untreated as described above. The media in this case had the lowest pore size (<7 μm).

### EXAMPLE 2

### Filtration Caking Tests

Test dust consisting of fine particles of silicon dioxide was prepared. The particle size of the test dust was measured using laser diffraction techniques. Particles were passed through a focussed laser beam and scattered light at an angle inversely proportional to their size. The angular intensity of the scattered light produced was measured by photosensitive detectors. The particle size distribution of the dust is shown in FIG. 2.

Each fabric (FM1-FM4 in Example 1) was tested in triplicate on a filtration test rig (FIG. 3). A weighed sample of filtration media was clamped in a filter housing (1) which was in turn inserted between the exit of a delivery tube (2) and vent (3). An air supply (4) was fed through a nozzle (5) to create an air flow passing through a dust feed chamber (6) into the delivery tube (2). 1.00 g of test dust was fed into the feed chamber (6) from a dust feed (7) over a 30 second period. The rig was run for a further 30 seconds. The filter and housing (1) was then removed, weighed and replaced in the reverse position. The filter was subjected to a thirty second burst of air, to remove the caked dust. The filter and housing (1) were weighed and the percentage cake release calculated.

The results are shown in FIG. 4. These show that the treatment appears to have a beneficial effect with respect to filter dust cake release in FM1, FM2 and FM3. In these cases, the treated filtration media exhibited superior cake release properties compared to equivalent untreated filtration media. The results for FM3 show that the chemical treatment was largely ineffective as compared to the treatment of the invention.

Although the sample of FM4 did not show this result, this may have been due to problems with the samples (see comments on permeability results above).

### EXAMPLE 3

### Tribocharged Filtration Media Testing

Sodium chloride aerosol is commonly used for air filtration testing. Samples of acrylic staple fibre, with and without the plasma treatment described in Example 1, were blended with polypropylene, carded to induce electrostatic charging, cross-lapped and needlepunched to produce a nonwoven filtration media.

These samples were then tested using methods based on the BS EN 13274-7:2002 sodium chloride aerosol test using the apparatus illustrated in FIG. 5.

A stream of compressed air is filtered in an air filter (8) in the direction of the arrow and into a aerosol generator (9). In the generator, a sodium chloride aerosol in the form of a polydisperse distribution of particles with a median particle diameter of about 0.6 μm is produced. This is then passed through a test chamber containing the test filter, whilst a parallel stream (11) by-passes this chamber. The concentration of particles in the aerosol before and after it has passed through the test filter is determined by means of flame photometry. A flame photometer (12) contains a hydrogen burner housed in a vertical flame tube through which the aerosol to be analysed flows. Sodium chloride particles in the air passing through the flame tube are vaporised giving the characteristic sodium emission as 589 nm. The intensity of this emission is directly proportional to the concentration of the sodium in the air flow. Accurate determinations are possible in the range <0.001% to 100% filter penetration.

The results obtained initially and also after 7 days are shown in Table 3.

TABLE 3

Penetration (%)

| Test Fibre | Initial Measurement | After 7 days |
|---|---|---|
| Untreated | 0.5 | 0.7 |
| Treated | 0.405 | 0.304 |
| treated | 0.428 | 0.331 |

These results showed that the treated electrostatic (tribocharged) filtration media gave a marked improvement in performance. A decrease in filtration performance brought about by aerosols is an established problem, and the treatment provides a clear means of alleviating this problem.

1-26. (canceled)

27. A fibrous filtration media whose fibre surfaces have been modified by exposure to a plasma deposition process so as to deposit a polymeric coating thereon.

28. The fibrous filtration media of claim 27, wherein fibres are exposed to the plasma deposition process before assembly into the filtration media.

29. The fibrous filtration media of claim 27, wherein the formed media is exposed to the plasma deposition process.

30. The fibrous filtration media of claim 27, which is an electrostatic (tribocharged) filtration media.

31. The fibrous filtration media of claim 27 selected from the group consisting of polypropylene, cellulose diacetate, poly(ethylene terephthalate), nylon, polyvinyl chloride, modacrylic, acrylic, cotton, silk or wool, which optionally may be at least one of chlorinated or coated with nylon or blends thereof.

32. A method for preparing a fibrous filtration media whose fibres surfaces have been modified by exposure to a plasma deposition process so as to deposit a polymeric coating thereon, the method comprising exposing either (i) the fibrous filtration media or (ii) fibres to a plasma comprising a hydrocarbon or fluorocarbon monomer so as to form a polymeric layer on the surface thereof and, in the case of (ii), forming a fibrous filtration media from the fibres.

33. The method of claim 32, wherein the plasma is pulsed.

34. The method of claim 32, wherein the monomer is a compound of formula (I) 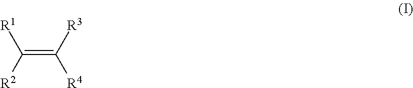
where R¹, R² and R³ independently are selected from hydrogen, halo, alkyl, haloalkyl or aryl optionally substituted by halo; and R⁴ is a group X—R⁵ where R⁵ is an alkyl or haloalkyl group and X is a bond; a group of formula —C(O)O(CH₂)ₙY— where n is an integer from 1 to 10 and Y is a bond or a sulphonamide group; or a group —(O)ₚR⁶(O)_{q}(CH₂)ₜ where R⁶ is aryl optionally substituted by halo, p is 0 or 1, q is 0 or 1 and t is 0 or an integer from 1 to 10, provided that where q is 1, t is other than 0.

35. The method of claim 34, wherein the compound of formula (I) is a compound of formula (II)
CH₂═CH—R⁵ (II)
where R⁵ is an alkyl or haloalkyl group, or a compound of formula (III)
CH_{2═}CR^{7a}C(O)O(CH₂)ₙR⁵ (III)
where n is an integer of from 1 to 10 and R⁵ is an alkyl or haloalkyl group and R^{7a} is hydrogen, C₁₋₁₀ alkyl, or C₁₋₁₀haloalkyl.

36. The method of claim 35 wherein the compound of formula (I) is a compound of formula (III).

37. The method of claim 36, wherein the compound of formula (III) is a compound of formula (IV) 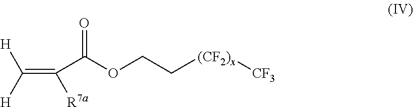
where R^{7a} is hydrogen, C₁₋₁₀alkyl, or C₁₋₁₀haloalkyl, and x is an integer from 1 to 9.

38. The method of claim 37, wherein the compound of formula (IV) is 1H,1H,2H,2H-heptadecafluorodecylacrylate.

39. The method of claim 32, wherein the filtration media or fibres are placed in a plasma deposition chamber, a glow discharge is ignited within the chamber, and a voltage is applied as a pulsed field.

40. The method of claim 39, wherein the applied voltage is at a power of from 40 W to 500 W.

41. The method of claim 37, wherein the voltage is pulsed in a sequence in which the ratio of the time on to time off is about 1:100 to 1:1500.

42. The method of claim 32, wherein in a preliminary step, a continuous power plasma is applied to the fibrous media or the fibres.

43. The method of claim 42, wherein the preliminary step is conducted in the presence of an inert gas.

44. The method of claim 32, wherein the coating is a hydrophobic coating.

45. The method of claim 32, wherein the fibrous filtration media or fibres are exposed to the plasma without the presence of a free radical initiator.

46. The method for preparing a fibrous filtration media of claim 32, the method comprising exposing either (i) a fibrous filtration media or (ii) fibres to a plasma comprising a hydrocarbon or fluorocarbon monomer in a plasma process without the presence of a free radical initiator so as to form a polymeric layer on the surface thereof, and in the case of (ii), forming a fibrous filtration media from the fibres, wherein the plasma is pulsed.

47. The method of claim 46, wherein the polymeric layer is hydrophobic.

48. A method of filtering fluids such as gases or liquids, the method comprising passing fluid through a filtration media whose fibre surfaces have been modified by exposure to a plasma deposition process so as to deposit a polymeric coating thereon.

49. The method of claim 48, wherein the fluid is air and the media is an electrostatic media that removes solid particles from the air.

50. A fibrous filtration media whose fibre surfaces have been modified by exposure to a plasma deposition process by the method of claim 32 so as to deposit a polymeric coating thereon.
